(19) United States
(12) Patent Application Publication
(10) Pub. No.: US 2008/0162232 A1
(43) Pub. Date: Jul. 3, 2008

(54) METHOD AND APPARATUS FOR BUSINESS PROCESS ANALYSIS AND OPTIMIZATION

(76) Inventors: David GAMARNIK, New York, NY (US); Nitin P. Jengte, Yorktown Heights, NY (US); Yingdong Lu, Yorktown Heights, NY (US); Bala Ramachandran, Harrison, NY (US); Mark Steven Squillante, Pound Ridge, NY (US)

Correspondence Address: Whitham, Curtis & Christofferson, P.C., Suite 340, 11491 Sunset Hills Road, Reston, VA, 20190, US

(21) Appl. No.: 12/050,422

(22) Filed: Mar. 18, 2008

Related U.S. Application Data
(63) Continuation of application No. 10/933,544, filed on Sep. 3, 2004.

(51) Int. Cl. G06Q 99/00

(52) U.S. Cl. 705/7

(57) ABSTRACT

A methodology for business process analysis and optimization. This enables firms to analyze business processes using stochastic processing network models to estimate process key performance indicators. Based on these indicators, alternate process models can be further developed and analyzed, in order to optimize business objectives. The analysis methodology can be used for business process design (at design time) and for business process management (at run time).

### BACKGROUND OF THE INVENTION

1. Field of the Invention

The present invention generally relates to a method and apparatus for analysis and optimization of business processes in order to achieve specified business performance objectives and, more particularly, to estimate business process bottlenecks and optimize resources to improve process performance.

2. Background Description

Business Performance Management is a key emerging technology positioned to enable optimization of business operations and Information Technology (IT) infrastructure so as to achieve performance targets (see J. van Decker & D. Baltaxe, “Business Performance Management Study—(1) Initiatives & Leadership (2) Preferences, Adoption Patterns and the Future”, Meta Group, October 2003). This is done by continually monitoring and optimizing the attributes of a business—not just during business process design, but also after the business process has been deployed. In order to do this, capabilities to analyze and optimize business process performance are important. These capabilities need to be applicable to changing conditions in the business process environment and to uncertainties in various business process attributes.

Traditionally business process simulation has been used to analyze business processes (see M. Laguna & J. Marklund, “Business Process Modeling, Simulation and Design”, Prentice Hall, 2004). This provides useful insights such as process & resource bottlenecks, costs etc., but is however a time-consuming process and a majority of business process analysts do not use this capability. In some cases, case analysis and weighted average analysis is used (see IBM WBI Modeler Users Guide, 2004). However, this does not provide insightful information about business process performance bottlenecks.

The background described above indicates a need for methods to rapidly analyze business processes, so they can be used to better design and manage business process performance.

### SUMMARY OF THE INVENTION

It is therefore an object of the present invention to provide a method and apparatus that enable the analysis of business process attributes to determine key performance indicators.

It is another object of the invention to provide a method and apparatus that enable the optimization of the business process in order to achieve specified business performance objectives.

According to the invention, a stochastic model representation of a business process is developed. Analytical techniques are then used to derive performance metrics for the business process and, further, to optimize them. The invention establishes connections between the design and control of business processes and mathematical models of stochastic processing networks. With this correspondence, the macroscopic planning of the resources for the business process are carried out through identifying optimal topological structures of the stochastic processing networks. An optimal topology for a business process is understood as any network topology which results in the lowest possible cost of the business processes and which satisfies the necessary constraints on the topology and optimizes the business key performance indicators. The method for determining the optimal topology of consists of the following steps:
1. Formulating a stochastic processing network model for the business process.
2. Identifying the constraints on the topology. Examples of such constraints are: the network must be a cluster, the network must be a connected graph, the network must contain at least so many layers, etc.
3. Identifying the cost structure of the topology. The cost is understood as a function of the topology.
4. Identification of the optimal topology by finding the topology which minimizes the cost and optimizes the business key performance indicators among the space of topologies satisfying the constraints.

The microscopic management of the business process will be carried out through mathematical analysis of the stochastic processing networks with given topological structure. This is accomplished in the following steps:
1. Convert the business process to its underlying stochastic processing network description.
2. Solve the stochastic processing network, this includes calculations of key statistics of the network, and/or optimization of the parameters of the network to meet pre-specified goals.
3. Identify the parameters and structures of the business processes that are essential to the implementation of the results obtained in step 2; adjust and fine-tune the parameters and structures according to the guidance as the result of step 2.

The invention contemplates the use of these analysis and optimization techniques both in the design of business processes (at design-time) and in run-time management of business processes (at run-time).

### BRIEF DESCRIPTION OF THE DRAWINGS

The foregoing and other objects, aspects and advantages will be better understood from the following detailed description of the invention with reference to the drawings, in which:

FIG. 1 is a block diagram showing how the invention can be used at design-time for business process design.

FIG. 2 is a block diagram showing how the invention can be used at runtime to manage business process performance.

FIG. 3 is a block diagram showing the components of Business Process Analysis, as per this invention

FIG. 4 is a block diagram showing the sequence of steps in the Development of the Fluid model, as an illustrative example

FIG. 5 is a block diagram showing the sequence of steps in the Estimation of Business Process Key Performance Indicators.

FIG. 6 is a diagram showing an example business process.

FIG. 7 shows resulting outputs upon solving the illustrative fluid model for the example business process.

FIG. 8 illustrates a block diagram of the environment and configuration of a computer system for incorporating the present invention.

### DETAILED DESCRIPTION OF THE INVENTION

Every enterprise has multiple business processes executing its strategy using different types of resources. In general, a business process can be defined using an arbitrary combination of predefined constructs. We assume the existence of such constructs and a tool for constructing a business process using this. This invention is not limited by the specific details of a set of constructs. For example, the description below outlines a set of constructs that can be used to model business processes.
Information Artifacts—This describes items that flow through the process at different stages.
Task—This describes an activity in the business process. Resources with specific roles may be required to perform the task. Tasks can have multiple characteristics such as costs, task logic, etc. A task can have multiple input and output ports each of which can be associated with a multiplicity. An input port multiplicity of N means that an instance of the task is triggered for every N information artifacts coming through that port. An output port multiplicity of N means that for every triggered instance of the task, N output information artifacts are sent out. Logic can also be used to specify the output ports that should be used corresponding to each input port.
Process—This is a group of tasks and other processes, thus enabling hierarchical decomposition of a business process into lower level processes and tasks.
Forking/Decisions—These involve branching of the process to follow different paths. In forking, the multiple paths are pursued simultaneously, by creating copies of the information artifacts. In decisions, only one of the multiple paths is pursued. Decisions can be binary and in general, can have multiple choices and can have logic associated with them, that determine the output path followed by an output information artifact.
Merge/Join—This is the converse of process branching, where multiple input flows come together to pursue a common output flow. In joining, information artifacts arriving through the multiple flows all have to arrive before the common output flow is triggered. In merging, the output flow is triggered whenever information artifacts arrive through any of the input flows.
Start/Stop—This describes the starting and end points of the business process.

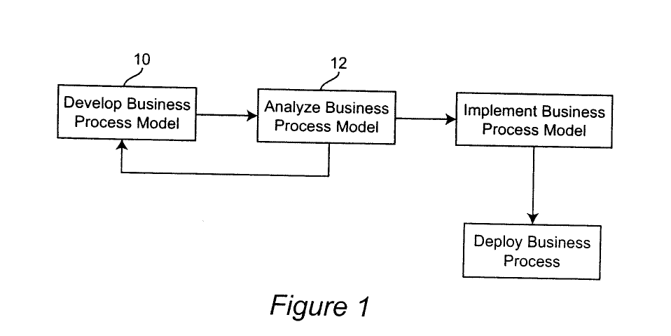

Referring now to the drawings, and more particularly to FIG. 1, there is shown a scheme for business process design. Develop Business Process (10) models a business process based on predefined constructs. This model is then analyzed in Analyze Business Process Model (12). The invention presented in this disclosure enables a new method to do Analysis of Business Process Models (12). The modeling and analysis is an iterative process that is done until the performance indicators from the process design are satisfactory. This process can then be implemented and deployed. This is a general scheme that is part of the prior art. The invention described here can also be used as part of this scheme, in particular in the Analyze Business Process Model (12) step.

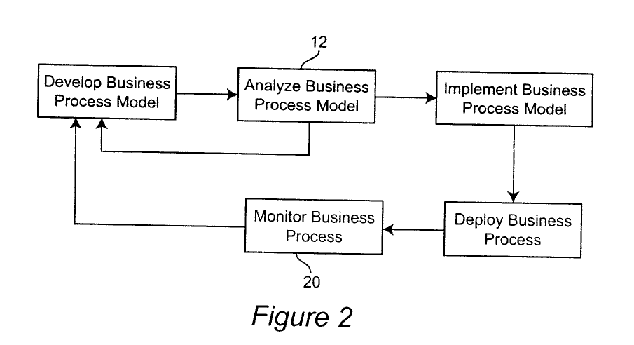

FIG. 2 describes the overall business transformation lifecycle, that includes both design-time and run-time. In addition to the steps described in FIG. 1, this also contains the run-time monitoring and management of situations in the deployed business process. In the Monitor Business Process step (20), business process situations are detected and alerts are communicated to process owners using appropriate communication medium, such as a dashboard. The process owners may then explore alternative methods to manage the situation, by developing different scenarios and analyzing the process models (12). The analysis results are then interpreted by an expert and the chosen method is then implemented. Thus, the analysis method described as part of this invention can also be used in a run-time scenario for monitoring and management of business processes.

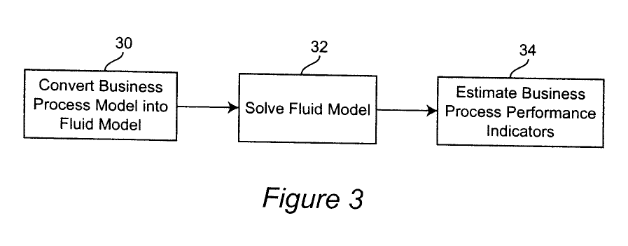

FIG. 3 describes the steps in the invention, based on a specific illustrative example method for modeling stochastic modeling networks, called fluid models. First the business process model is converted to a fluid model (30). Then the fluid model is solved (32) and based on this, the business process key performance indicators are computed (34). This invention is by no means limited to the specific details of the fluid model, but any stochastic processing network model is within the scope of the invention. This includes, but is not limited to, Brownian models, Markov processes, and general probability models.

Based on the specification of the business process, the fluid model (represented by its matrices) can be generated. Fluid networks are a class of mathematical objects characterizing systems with piece-wise constant rate of changes. They are used to characterize the first order dynamics for stochastic processing networks, and they have been adopted in analyzing and optimizing the performance of complex networks found in telecommunications and manufacturing. The basic definition and methodology is described in many standard textbooks for stochastic networks, for example, Chen and Yao, Fundamentals of Queueing Networks, 2002, Springer-Verlag. These systems are best characterized by a system of linear equations of the relations between the flow level, i.e. the quantity of the surplus, and the utilization of the resources.

However these standard fluid models in the prior art cannot be used to address key aspects of business processes as described below. This invention develops methods and apparatus for analysis and optimization of general business processes in order to achieve specified business performance objectives. Using these methods, we can achieve the following two goals for the analysis of general business process:
(1) efficiently calculate the utilization of each resource and throughput of the entire business process and related key performance indicators of the business process
(2) Identify the resource and process bottleneck(s) and quantify the required resource and process capacity for achieving the targeted performance levels.

Let us assume that the fluid network contains N queues. The standard fluid model is described by:
P: Connectivity—Matrix where pᵢⱼ represents proportion of traffic from queue i to queue j, after processing by the server associated with queue i.
   Dimension of P: N×N
α: Arrival rate—Vector where αᵢ specifies the arrival of external traffic to queue i.
   Dimension of α: N×1
M: Processing Duration—Diagonal matrix where mᵢᵢ specifies the mean processing Duration for queue i. Note if the capacity of a resource type is more than 1 (e.g., 100 salespersons), the processing duration of the queue is scaled by the capacity (aggregating all resources into one, that can process at a faster rate)
   Dimension of M: N×N

For the standard fluid model, u, the vector of utilization at each resource can be obtained by the following formula,

u=M(I−P′)⁻¹α
where I is the identity matrix and P′ is the transpose of P.

Due to the specific features of business process, the fluid model generated is not in standard form, i.e. the fluid model for a conventional stochastic processing network. Mathematically, it is reflected by the fact that the matrix (I−P′) could be singular, hence, the fundamental analysis of the fluid model cannot be performed directly. Therefore, the first step in the analysis is to construct another fluid model that satisfies
(1) standard model form for a conventional stochastic processing network, e.g. P is a stochastic matrix;
(2) the throughputs of the two fluid models are the same, and so are the utilizations for each resource.

For business processes that have different constructs, the standard fluid model can be generated through the following procedures:
(1) Multiplicity: the new fluid network will have the same structure but different depletion rate to accommodate the phenomenon of multiplicity. For input port multiplicity of n, we replace the server with depletion rate μ by a server with depletion rate μn; for output port multiplicity, we replace the corresponding entry pᵢ of the routing matrix P with pᵢⱼn.
(2) Fork/Join: In the new fluid network, all the parallel fork/join features are replaced by a serial system. To be more specific, the simultaneously pursued paths will be replaced by paths pursued in tandem; similarly, in the join process, the output flow is triggered when the information artifacts go through all the required tasks in tandem. Alternatively, fork/join features can be handled by appropriately modifying the arrival rates and the routing matrix.
(3) Merge: It happens when there are several different paths that can trigger the same output, and the output is triggered by the earliest arrival. We can compute the rate at each path, then replace them by a single path, and assign the rate as the summation of the rates of the old paths.

Based on the specification of the business process (BP), the fluid model (represented by its matrices) is generated as follows:
information artifacts are modeled as surplus in the fluid networks.
Associate queues with every BP activity—the number of queues defined for each BP activity is equal to the number of resource types for performing the activity (Total Number of queues−N). Queue is a combination of task, resource requirement and input port. For example, if a task requires n resources to execute and has m input ports, this will imply n*m queues.
Define a router (a) for every decision node in the business process and (b) where copies of business artifacts are used
Generate matrices (P, α, M) defining this fluid model.

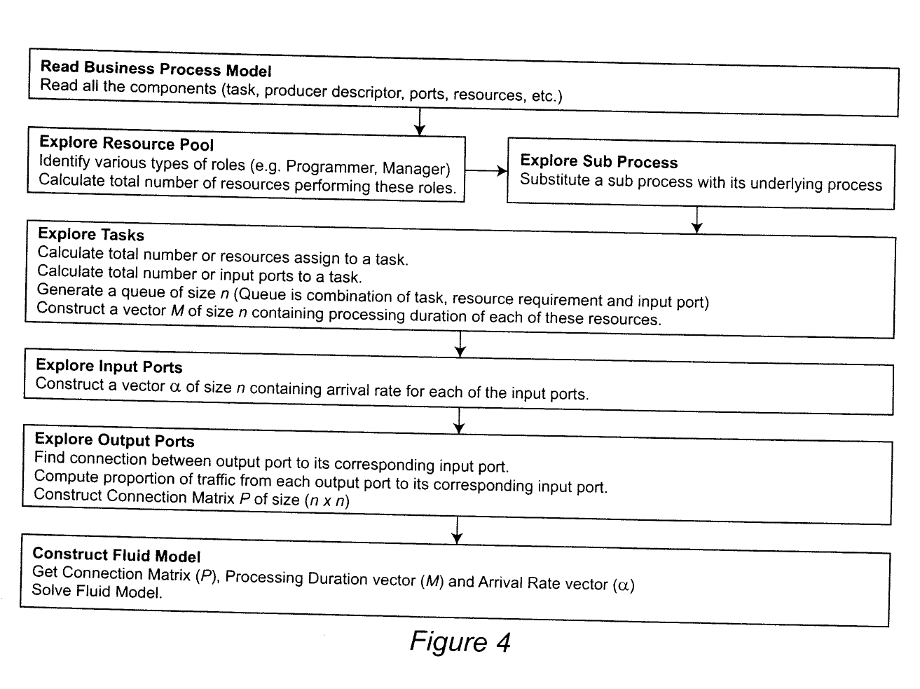

We now describe how the above Business Process constructs are converted to above defined parameters (P, α, M) to generate a Fluid model. FIG. 4 is a block diagram showing the sequence of steps in the Development of the Fluid Model (32).

### Calculating P (Connection Matrix)

Here are the various considerations while calculating the value of pᵢⱼ (proportion of traffic from queue i to queue j).

1. If a task T1 with n resources is connected to a task T2 with any number resources then the value of pᵢⱼ (proportion of traffic from queue i of task T1 to queue j of task T2) is equal to multiplicity of output port of task T1/n.
2. If n number of tasks (T_{1 . . . n}) are connected to a Join task (joining) then the value of pᵢⱼ (proportion of traffic from queue i corresponding to task Tᵢ to queue j of Join task) is equal to multiplicity of output port of Tᵢ/n.
3. If a Fork task is connected to n number of tasks (T_{1 . . . n}) then the value of pᵢⱼ (proportion of traffic from queue i of Fork task to queue j of T_{1 . . . n} tasks) is equal to multiplicity of output port of Fork task.
4. If n number of tasks (T_{1 . . . n}) are connected to a Merge task (merging) then the value of pᵢⱼ (proportion of traffic from queue i of T_{1 . . . n} task to queue j of Merge tasks) is equal to multiplicity of output port of tasks (T_{1 . . . n}).
5. If a Decision task with n number of branches is connected to n number of tasks (T_{1 . . . n}) then the value of pᵢⱼ (proportion of traffic from queue i of Decision task to queue j of T_{1 . . . n} tasks) is equal to probability value of each branch*multiplicity of output port of each branch.
6. If n number of tasks (T_{1 . . . n}) are connected to a single task with n number of ports and if all these n ports belongs to same portset then it acts like a Join (Scenario 2).
7. If n number of tasks (T_{1 . . . n}) are connected to a single task with n number of ports and if all these n ports belongs to n different portsets then it acts like-a Merge (Scenario 4).

The above mentioned scenarios are the basic elements, but a more complex scenario can be any combination of the above 7 scenarios.

Each Join needs to be checked for consistency as follows: the effective arrival rate into each queue of the join must be the same. The effective arrival rates computation is described below.

Calculating α (Arrival rate)

αᵢ=Number of tokens per hour arriving from an external source to an input port in a queue

Calculating M (Processing duration)

Consider a task T1 having n input ports (IPₙ), m output ports (OPₘ) and r resources (Rᵣ)

For any given queue the mean Processing duration is:

mᵢ=(Mean Processing time of a resource Rᵣ*multiplicity of the input port IPᵢ*Total number of resources Rᵣ in that task)/Total number of resources Rᵣ in whole process

After deriving the matrices (P, α, M), the vector of utilization at each resource (u) can be obtained by the following formula,

U=M(I−P′)⁻¹α

If the utilization is larger than one, the network is not stable, i.e. if we allow the system runs under the current condition, the workload for this particular resource could build up indefinitely.

If we specify u, the utilization at each resource, then the required capacity can be obtained throughput the following equations.

v=(I−P′)⁻¹α, μᵢ>=vᵢ/uᵢ

where v is the vector of effective arrival rates.

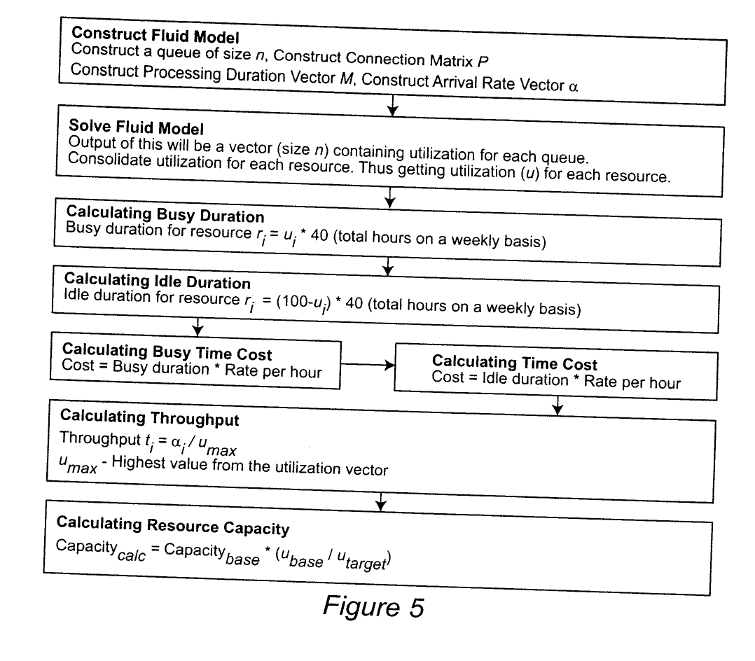

After constructing the matrices (P, α, M) we solve the Fluid Model. The result we get after solving this model is a vector containing utilization for each queue. Since multiple queues can be associated with the same resource, we consolidate all of the results to come up with the utilization for each resource. FIG. 5 describes the calculation of the business process key performance indicators for this illustration. For simplicity we will show all the KPI calculation based on weekly basis (we assume that the number of working hours per week=40).

### Busy Duration

Busy duration is the duration for which the resource has been utilized by the process. Busy duration is calculated as utilization of the resource*40.

### Idle Duration

Idle duration is the duration for which the resource was not utilized by the process. It is calculate as total duration (40)−busy duration.

### Busy Time Cost

Cost incurred for utilizing the resource. It is calculated as busy duration*cost of the resource per hour.

### Idle Time Cost

Cost incurred when the resource was idle. It is calculated as idle duration*cost of the resource per hour.

### Throughput

Maximum number of transactions a process can handle without getting unstable. It is calculated as arrival rate/highest utilization.

### Resource Capacity

The resource capacity to get a desired resource utilization is calculated as base capacity of the resource*base utilization of the resource/desired resource utilization.

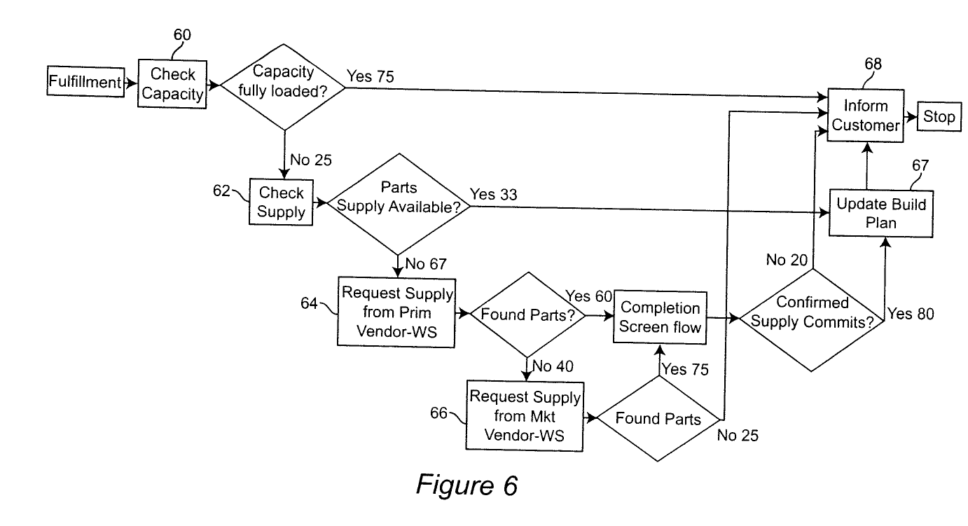

We illustrate the invention based on a supply chain scheduling example that is illustrated in FIG. 6. (see K. Bhaskaran and M-T. Schmidt, “Websphere Business Integration: An Architectural Overview for details).

This example is based on an electronics supply chain, where a customer changes an existing order with the manufacturer. The manufacturer checks the inventory and may fulfill the order. If supply is insufficient, the manufacturer would seek to identify when they can manufacture the additional quantity based on manufacturing capacity (60) and available component supply (62). If component supply is insufficient, then the manufacturer seeks additional supply either from a primary vendor (64) or secondary sources of supply (66), such as a spot market. The manufacturer updates the build plan (67), either if he has the supply or is able to obtain additional supply from primary or secondary vendors. The manufacturer then proceeds to inform the customer (68), whether or not he is able to satisfy the requested order change.

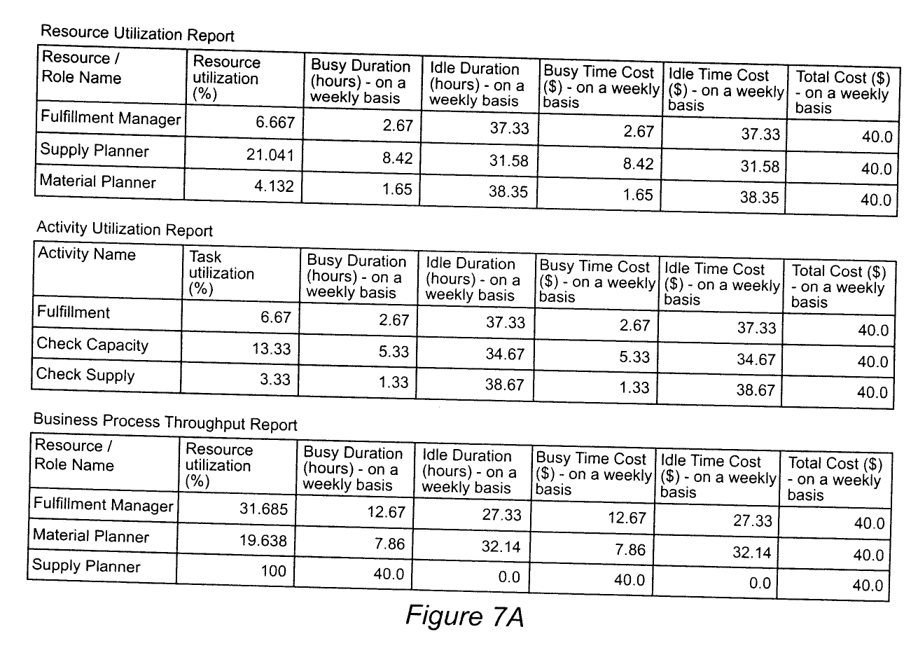

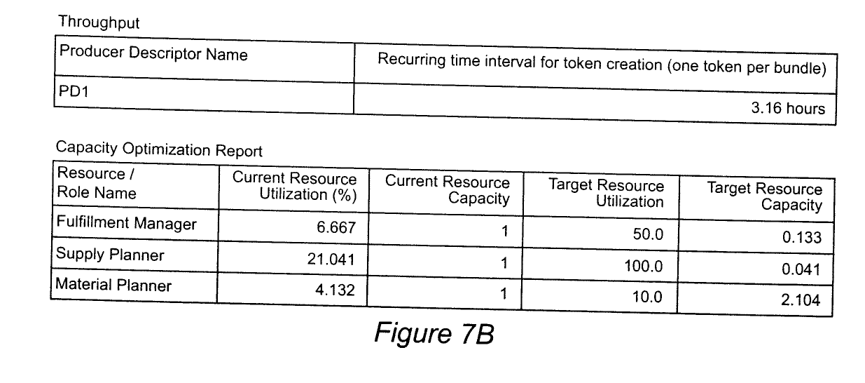

FIG. 7 shows some results from the solution of this problem using the fluid model, that is described below.

### Resource Utilization Report

This report shows all the resource/role needed to execute this process. It shows, how much the resource is utilized, what was the busy duration and idle duration for these resources. It also shows the busy time cost, idle time cost and total cost for each resource.

For example—consider Fulfillment Manager's rate per hour as $1.00. Fulfillment Manager was utilized for 6.6%. On weekly basis (40 hours) Fulfillment Manager was busy for 2.67 hours and was idle for 37.33 hours. Busy time cost, idle time cost and total cost of Fulfillment Manager for the entire week was $2.67, $37.33 and $40.0 respectively.

### Activity Utilization Report

This report shows all the activities done in this process. It shows how much the activity is utilized, what was the busy duration and idle duration for these activities. It also shows busy time cost, idle time cost and total cost for each activity.

For example—Check Capacity was utilized for 13.33%. On weekly basis (40 hours) Check Capacity was busy for 5.33 hours and was idle for 34.67 hours. Busy time cost, idle time cost and total cost of Check Capacity for the entire week was $5.33, $34.67 and $40.0 respectively.

### Business Process Throughput Report

This report is same as that to the Resource Utilization report. The only difference is, this report shows the result calculated for maximum throughput.

### Throughput

This report shows name of all the producer descriptors (external arrivals to the process) and the recurring time interval for token creation (in hours) For example, the Producer descriptor PD. has a recurring time interval for token creation as 3.16 hours means that if one token is created per 3.16 hours by this producer descriptor, utilization of one of the resource will be 100%. Or we can say that the maximum throughput this process can handle is one token per 3.16 hours. If this value is less that 3.16 hours the process will not be stable.

### Capacity Optimization Report

This report show all the resources for which a user want to see the changes in the resource capacity for a changes resource utilization. For example, the Material Planner's current utilization is 4.13%. If it is desired to increase the utilization of Material Planner to 10%, the capacity of Material Planner need to be doubled (2.104).

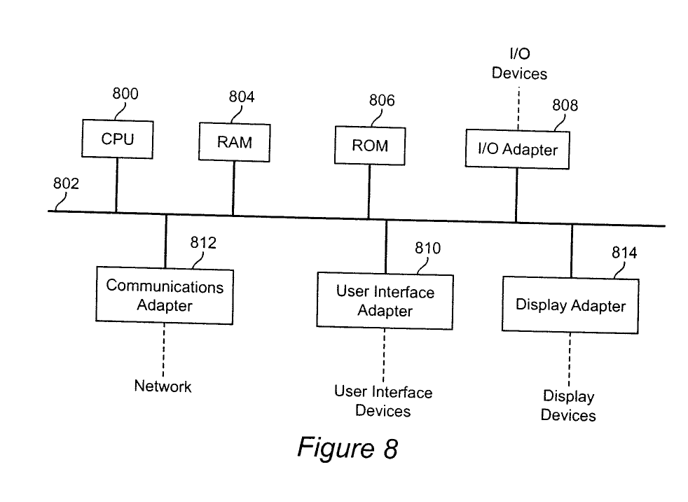

FIG. 8 shows a typical hardware configuration of a computer system in accordance with the invention that preferably has at least one Central Processing Unit (CPU) 800. The CPUs are interconnected via a system bus 802 to a random access memory (RAM) 804, read-only memory (ROM) 806, input/output adapter 808 (for connecting peripheral devices such as disk units and tape drives to the bus), user interface adapter 810 (for connecting user devices such as keyboard, mouse, etc. to the bus), communication adapter 812 (for connecting the computer system to an information network such as Internet, Intranet, etc.) and a display adapter 814 (for connecting the bus to a display device)

In addition to the environment in FIG. 8, a key aspect of this invention includes a computer implemented method for business process analysis and optimization. As an example, this method may be implemented in the particular hardware environment discussed above. The method may be implemented, for example, by operating a computer, as embodied by a digital data processing apparatus to execute a sequence of machine-readable instructions. These instructions may reside in various types of signal-bearing media such as a CD diskette, etc.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for analyzing and optimizing business processes comprising the steps of:
identifying a family of inputs subject to defined constraints, that together describe the business process;
operating upon the family of inputs according to at least one of the techniques selected from the class of fluid flow models, Brownian models, Markov processes, general probability models and so on, and general optimization to produce a set of outputs which satisfy defined constraints; and
operating recursively on said inputs and resulting outputs, in order to apply the above method to the entire business process

2. The method according to claim 1, wherein the analysis is performed on different alternatives of the business process topology to determine an impact on overall business performance indicators.

3. The method according to claim 1, wherein the analysis is performed on different alternatives of the business process parameters to determine an impact on overall business performance indicators.

4. The method according to claim 1, wherein the outputs of the analysis are used to determine the business process topology for deployment.

5. The method according to claim 1, wherein the outputs of the analysis are used to determine the attributes of the business process for deployment.

6. The method according to claim 1, wherein the method is used at design time for Business Process Modeling and Design, with the inputs for the analysis being obtained from Business process modeling systems.

7. The method according to claim 1, wherein the method is used at runtime for Business Performance Management, with the inputs for the analysis being obtained from Business Performance Management systems.

8. The method according to claim 1, wherein the method is incorporated in a computer system or any other suitable electronic device.

9. A method for determining an optimal topology for a business process comprising the steps of:
formulating a stochastic processing network model for a business process;
identifying constraints on topology of the business process model;
identify a set of objectives and key performance indicators for the business process
identifying a cost structure for the topology, wherein the cost is a function of the topology,
identifying the optimal topology by finding the topology which optimizes the key performance indicators (including costs) for the business process, among the space of topologies satisfying the constraints.

10. A method for managing a business process through mathematical analysis of stochastic processing networks with a given topological structure comprising the steps of:
converting the business process to its underlying stochastic processing network description;
solving the stochastic processing network, including calculating the key performance indicators for the network;
identifying parameters and structures of the business process that are essential to an implementation of the results obtained from the solution of the stochastic processing network; and
adjusting and tuning the parameters and structures of the business process according to the results obtained from the solution of the stochastic processing network.

11. A computer system for business process analysis and optimization, at design-time, comprising the steps of:
modeling a business process using different business process constructs;
formulating a stochastic processing network model for a business process;
solving the stochastic processing network, including calculating the key performance indicators for the network;
modifying the business process model based on the results obtained from the solution of the stochastic processing network.

12. A computer system for business process analysis and optimization, at run-time, comprising the steps of:
modeling a business process using different business process constructs;
formulating a stochastic processing network model for a business process;
solving the stochastic processing network, including calculating the key performance indicators for the network;
identifying parameters and structures of the business process that are essential to an implementation of the results obtained from the solution of the stochastic processing network; and
adjusting and tuning the parameters and structures of the business process according to the results obtained from the solution of the stochastic processing network.
